(19) United States
(12) Patent Application Publication
(10) Pub. No.: US 2008/0302611 A1
(43) Pub. Date: Dec. 11, 2008

(54) Machine Room with a Raised Work Platform in Front of the Controller for Elevators and Elevator Equipped Therewith

(76) Inventors: Gerard Sirigu, Gien (FR); Jean-Noel Cloux, Nogent Sur Vernisson (FR); Michel Beeuwsaert, Nevoy (FR)

Correspondence Address: OTIS ELEVATOR COMPANY;INTELLECTUAL PROPERTY DEPARTMENT, 10 FARM SPRINGS, FARMINGTON, CT, 06032, US

(21) Appl. No.: 11/659,049

(22) PCT Filed: Sep. 3, 2004
(86) PCT No.: PCT/IB04/02897

§ 371 Date: Jan. 31, 2007

(51) Int. Cl. B66B 11/04

(52) U.S. Cl. 187/276

(57) ABSTRACT

The machine room according to the invention with a flat rope or thin rope drive machine is, characterized in that the elevator controller device (19) is placed near the machine frame (17) equipped with the return pulleys and is higher than the floor (11) of the machine room by at least the same height as that of the machine frame (17), and in that a work platform (29) is arranged in front of the controller device (19), over or on the machine frame (17), at least on part of its upper part, so as to allow operator access to the controller device (19) from said platform (29)

This invention relates to a machine room with a raised work platform in front of the controller for elevators and to an elevator equipped therewith.

Attempts are being made to minimize the space occupied by the machine room in elevators in order to provide more space for the other service elements in the corresponding equipment room of the building, e.g. for ventilation, air conditioning, aerials, etc., as well as to reduce building costs.

In addition, elevators with a flat rope drive machine or with small diameter ropes drive machine are known to be equipped with a machine frame in which return pulleys are small and which has a small height, not exceeding 0.25 m, while this frame takes up a considerable footprint in the machine room.

The invention aims at advantageously using this low height characteristic of the machine frame to reduce the footprint of these elevators in the machine room.

The invention proposes a machine room for elevators, characterized in that the elevator controller device is placed near the machine frame equipped with the return pulleys and is higher than the floor of the machine room by at least the same height as that of the machine frame, and in that a work platform is arranged in front of the controller device, over or on the machine frame, at least on part of its upper part, so as to allow operator access to the controller device from said platform.

In this arrangement, the arrangement of the work platform for the controller device, which is set up as per standard EN 81-1 of the safety code on or above the frame of the return pulley machine for the elevator, provides a large additional floor space, with the minor disadvantage of creating a step as high as the platform, which has advantageously with small return pulley machine a relatively low height of less than 0.25 m, on the machine room floor,

Said platform extends just in front of the controller device over a width that is at least equal to that of the controller device.

It is fixed to the machine frame, e.g. by screws engaged into the frame, so as to allow the operator to stand in a stable position in front of the controller device.

This platform can also) be used as an upper cover for the machine frame, which it then covers completely.

The controller device can be raised by a conventional support with feet enabling cables to be laid under the controller device, at an appropriate height to allow opening the doors of the controller device over the platform.

In an advantageous configuration, the controller device is placed opposite the elevator drive motor with relation to the machine frame so as to provide an optimal footprint with the motor located close to the machine frame, which machine frame can in addition be placed substantially in the middle of the machine room.

Thus the machine room elements can be set up over a surface that can be enclosed in and smaller than the cross-section of the elevator shaft, but is advantageously equal to that cross-section in order to take advantage of the bearing walls of the shaft to erect the machine room walls in continuity over the shaft ceiling slab.

The invention also logically relates to an elevator equipped with a machine room such as defined above.

An exemplary embodiment is then described with reference to the appended drawings, in which:

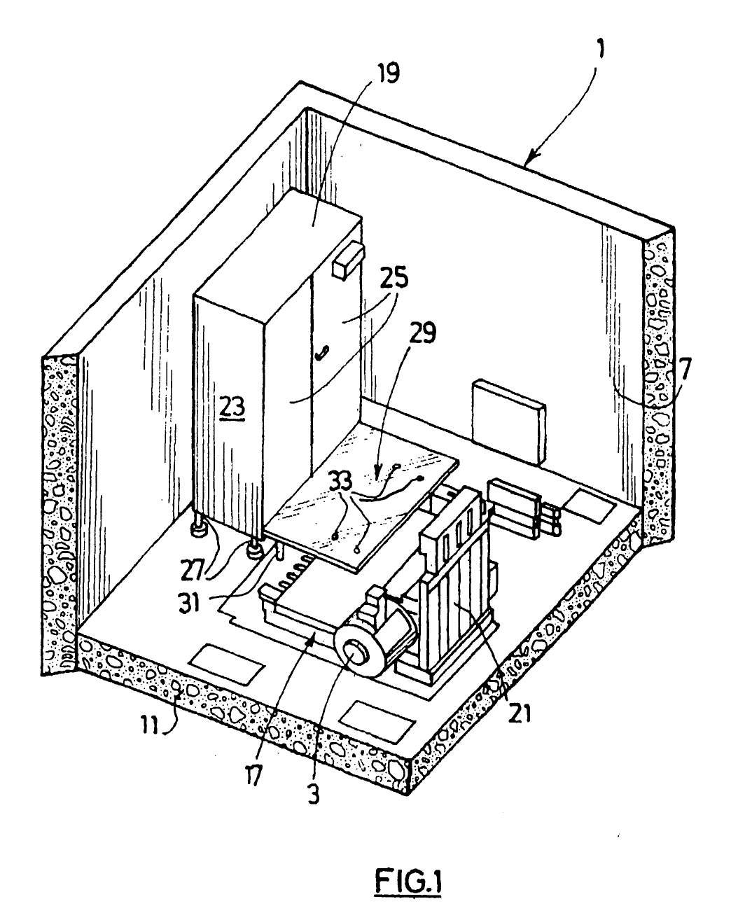

FIG. 1 is a general perspective view of an elevator machine room as per the invention;

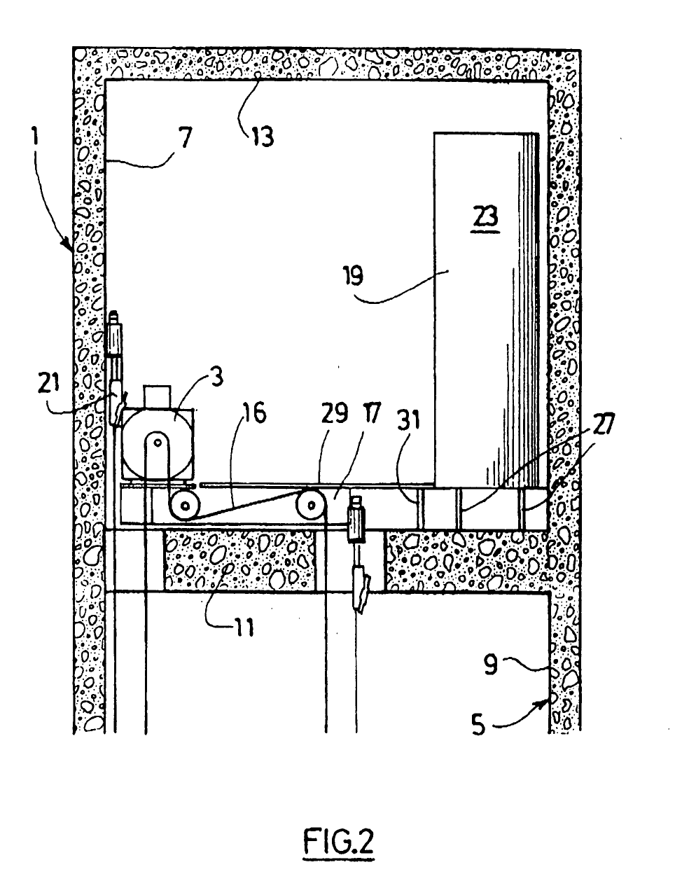

FIG. 2 is a middle cross-section of this machine room;

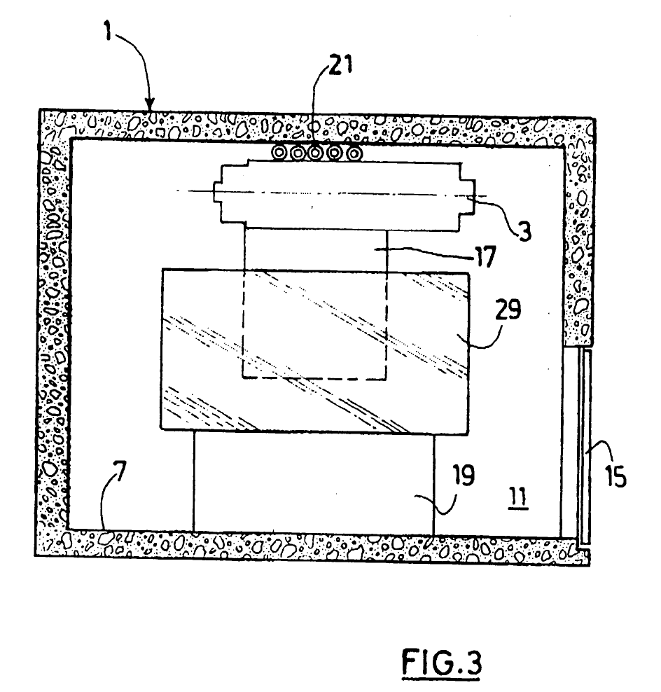

FIG. 3 is a top view showing the arrangement of the elements in the elevator machine room.

Referring now to FIGS. 1 to 3, the machine room 1 according to the invention is for an elevator with a flat rope or thin steel rope drive motor 3, having a great capacity and a high car travel speed and operating over multiple stories of a building, which machine room 1 is included in a top space above the elevator shaft 5 containing service elements, e.g. for air conditioning, aerials, etc., for the building (not represented).

The machine room 1 is enclosed by walls 7 extending vertically in the continuation of the walls 9 of the elevator car shaft, above the ceiling slab 11 thereof, and up to the roof 13 of the machine room. This room is provided with a locked door 15 restricting access to authorized personnel.

The machine room 1 thus arranged in the vertical projection of the shaft 5 contains, as usual, a drive motor 3 with a flat rope 16 or thin steel ropes and thus with small-diameter pulleys, a machine frame 17 with return pulleys returning the ropes 16 to the elevator car, an elevator controller device 19 and other accessories such as the dead end elements 21 of the drive ropes.

The motor 3 is arranged on the side and substantially in a median plane of the machine room. The machine frame 17 is contiguous to the motor 3 and placed substantially in the middle of the machine room. It is made of a substantially rectangular casing with a flat, low-profile upper surface having a height of about 0.2 m.

The controller device 19 is arranged on the other side of the room relative to the motor 3, substantially in the median plane mentioned above and thus opposite the motor 3 relative to its frame 17. It is made of a cabinet 23 containing the elements making up the controller and with doors 25 on its front side that can be opened forwards by an operator to access the elements making up the controller. This cabinet 23 is raised to at least the height of the machine frame by a set of feet 27 or a similar support.

A work platform 29 is arranged in front of the controller device at the base of its cabinet 23. It is made of a stiff metal plate raised to the height of the frame, i.e. about 0.2 nm, bib feet 31 in its front part, and is screwed on top of the frame in its rear part using screws 33. This plate is rectangular and has a length at least equal to the width of the controller device 19 and a width extending behind the controller cabinet of at least 0.7 m horizontally, which complies with the safety standards for operator work on the controller device. The operator accesses the platform as a step about 0.2 m high relative to the machine room floor 11 and thus has a stiff, stable platform at his disposal to access the controller device by opening the cabinet doors just above the platform.

Of course, the platform 29 can be disassembled by simply loosening the screws 33 and removing it from the machine frame 17 to access the machine frame as required.

Variations of the geometric position of the elements set up in the machine rooms are possible as long as a raised platform with dimensions compliant with safety standard is installed in front of the controller device cabinet, which is also raised, to allow access thereto for an operator on the platform (with the operator opening the cabinet doors and accessing the components at work level), wherein the platform is arranged above at least part of the machine frame by means of an appropriate support, thus reducing the footprint of machine room components.

1.-14. (canceled)

15. A machine room for elevators comprising:
an elevator controller device being placed near a machine frame that includes return pulleys and being higher than a floor of the machine room;
a work platform that is arranged in front of the controller device,
wherein the work platform extends over or on the machine frame so as to be located over at least one of the return pulleys and to allow an operator access to the controller device from the work platform.

16. The machine room of claim 15, wherein said controller device and platform are raised by a height approximately equal to that of the machine frame.

17. The machine room of claim 15, wherein the work platform is removeably mounted to allow access to the machine frame.

18. The machine room of claim 15, wherein said platform is arranged on the upper surface of the frame.

19. The machine room of claim 15, wherein said platform extends just in front of the controller device over a width that is at least equal to that of the controller device.

20. The machine room of claim 15, wherein said platform is fixed to the machine frame, so as to allow the operator to stand in a stable position in front of the controller device.

21. The machine room of claim 15, wherein said platform is a stiff metal plate raised horizontally relative to the floor of the machine room by means of a support device.

22. The machine room of claim 15, wherein the controller device is raised by a support such that cables are configured to be laid under the controller device at an appropriate height to allow opening of doors of the controller device over the platform.

23. The machine room of claim 15, wherein the controller device is placed opposite an elevator drive motor with relation to the machine frame, and wherein the motor is located close to the machine frame.

24. The machine room of claim 23, wherein the machine frame is placed substantially in the middle of the machine room.

25. The machine room of claim 15, wherein the machine room components are set up over a surface enclosed in and smaller than the cross-sectional area of the elevator shaft.

26. The machine room of claim 15, wherein the machine room components are set up over a surface equal to the cross-section of the elevator shaft in order to take advantage of bearing walls of the shaft so as to erect the walls of the machine room in the continuity thereof on the ceiling slab of the shaft.

27. An elevator system comprising:
a machine room for elevators comprising:
an elevator controller device being placed near a machine frame that includes return pulleys and being higher than a floor of the machine room;
a work platform that is arranged in front of the controller device,
wherein the work platform extends over or on the machine frame so as to be located over at least one of the return pulleys and to allow an operator access to the controller device from the work platform.
